(19) United States
(12) Patent Application Publication
(10) Pub. No.: US 2026/0057670 A1
(43) Pub. Date: Feb. 26, 2026

(54) DEEP LEARNING-BASED DETECTION OF VEGETATION ENCROACHMENT

(71) Applicant: Eversource Energy Service Company, Berlin, CT (US)

(72) Inventors: Bin Huang, Hamden, CT (US); Zefan Tang, Storrs, CT (US); Jiangwei Wang, Vernon, CT (US); Junhui Zhao, Woodbridge, CT (US); Sean Redding, Willington, CT (US)

(21) Appl. No.: 18/986,993

(22) Filed: Dec. 19, 2024

Related U.S. Application Data
(60) Provisional application No. 63/687,033, filed on Aug. 26, 2024.

(51) Int. Cl. G06V 20/10; G06V 10/26; G06V 10/764; G06V 10/82

(52) U.S. Cl. CPC G06V 20/188; G06V 10/273; G06V 10/764; G06V 10/82

(57) ABSTRACT

A method and system for deep learning-based automated detection of vegetation encroachment in overhead power distribution networks. A deep learning model can be used to detect vegetation encroachment in preprocessed images and frames and deep learning explainability tools can be used to identify irrelevant objects in the images that contribute to misclassification.

### CROSS-REFERENCE TO RELATED APPLICATIONS

The present application claims the benefit of U.S. Provisional Application No. 63/687,033 filed on Aug. 26, 2024, the subject matter of which is herein incorporated by reference in its entirety.

### FIELD OF THE INVENTION

The present invention relates generally to systems and methods for using deep machine learning to detect vegetation encroachments in power transmission and distribution systems.

### BACKGROUND OF THE INVENTION

Vegetation encroachments, such as trees growing too close to power lines (including both transmission and distribution lines), can lead to a range of issues, including power surges, momentary and sustained power outage, prolonged outages during storms and potentially brush or forest fires. According to a study released by Eversource Energy Center, trees are responsible for up to 90 percent of power outages during storms. Vegetation management is one of the most critical tasks for utility companies. It is a preventive and effective measure to improve the reliability and safety of power supply. Vegetation management starts with detecting vegetation encroachments, where utility companies assess the situation and take appropriate measures to trim trees and prevent damage to the power system under day to day and extreme conditions.

Utilities and/or power lines maintenance companies need to cyclically inspect these power lines to monitor and assess vegetation conditions and mitigate hazards from potential vegetation encroachments. Based on the vegetation condition inspection findings, the power line vegetation maintenance crews cut/trim or remove vegetation/trees that reach a threshold proximity to the power lines as predefined by the relevant regulatory agencies and utility companies.

Various federal, state, regional, and local level regulatory agencies oversee vegetation management compliance processes in the United States. The regulatory agencies and the utility companies within their jurisdictions have developed required minimum vegetation clearance distance (MVCD) parameter for power transmission and distribution lines based on the rated line voltages, minimum ground to conductor clearance (MGCC) requirements, geographic locations and their compliance inspection cycles. The maximum allowable vegetation height (MAVH) under or around high voltage power lines right-of-way (ROW) is mainly controlled by the MGCC and required MVCD parameters. The utility vegetation management line of business must ensure compliance to this MVCD requirements for the electric lines that they own or maintain. This electric transmission and distribution vegetation management is a mandatory compliance process that electric utility companies (including investors owned, publicly owned or privately owned), Transmission Owners (TO) and Generation Owners (GO) must carry out to ensure safe, reliable and affordable electricity supply to their customers and prevent any hazards to the environment from potential vegetation related flash-over hazards and resulting blackouts. Noncompliance to these regulations may impose steep fines and other punishments to the responsible utility companies, TO or GO.

Manual surveys are the primary method currently employed by utility companies to detect vegetation encroachments, and are typically conducted at regular intervals. However, this approach is labor-intensive and relatively inefficient. In addition to manual surveys, there have been efforts to utilize light detection and ranging (LiDAR) technology to capture the three-dimensional structure of power systems and vegetation, enabling analysis of vegetation encroachment through point cloud modeling. Additionally, satellite imagery has been employed to assess the intersection of transmission corridors and vegetation, facilitating the automation of vegetation encroachment detection. While LiDAR technology and satellite imagery offer promising solutions for vegetation encroachment detection in transmission systems, their applicability to distribution systems is limited due to the dispersed and smaller nature of distribution networks. The high costs associated with data acquisition and modeling make these approaches less feasible for distribution systems. Satellite imagery is also limited in effectiveness by dense canopy cover and canopy overhanging the distribution system.

To address the limitations of existing vegetation encroachment detection methods for distribution systems, this invention proposes a novel and cost-effective solution that preferably utilizes one or more sensors to capture footage of electrical power distribution assets, including conductors, transformers, insulators, poles, and associated hardware, and employs deep learning-based image classification techniques. In the context of vegetation encroachment detection, primary elements such as power lines, poles, electrical equipment, and vegetation are of interest, but street scenes often include unrelated objects such as roads, sky, and buildings, which lead to misclassifications by artificial intelligence (AI) models due to the lack of explicit features for normal conditions. This problem hinders the direct application of image classification techniques to the vegetation encroachments detection.

### BRIEF SUMMARY OF THE INVENTION

In the broadest sense, the present invention is directed to a method of deep learning-based automated detection of vegetation encroachment in overhead power distribution networks, wherein the method comprises one or steps disclosed herein, either individually or in combination with one or more of any other steps disclosed herein.

In preferred embodiments, one or more steps of the preferred methodologies is/are carried out by at least one processor.

In another preferred embodiment, the present invention is directed to a system for deep learning-based automated detection of vegetation encroachment in overhead power distribution networks, wherein the system comprises one or more features disclosed herein, either individually or in combination with one or more of any other features disclosed herein.

In yet another preferred embodiment, the present invention is directed to computer-implemented method of deep learning-based automated detection of vegetation encroachment in overhead power distribution networks, wherein the method comprises one or steps disclosed herein, either individually or in combination with one or more of any other steps disclosed herein.

In still another preferred embodiment, the present invention is directed to a non-transitory computer-readable medium with instructions stored thereon, that when executed by a processor, perform steps for deep learning-based automated detection of vegetation encroachment in overhead power distribution networks, wherein the steps comprise one or more of the steps disclosed herein, either individually or in combination with one or more of any other steps disclosed herein.

Although not limited to specific industries and/or fields of use, in a preferred embodiment, the present invention preferably provides a method for deep learning-based automated detection of vegetation encroachment in overhead power distribution networks. Preferably, the method involves the use of one or more sensors, which one or more sensors may be street level sensors, sensors mounted to utility poles and other fixed structures, overhead sensors including aerial and satellite sensors, sensors mounted to movable platforms, which platforms may be capable of movement in one or more of an X, Y, and Z direction in a planar coordinate system, and vehicle mounted sensors which are capable of capturing relevant footage or images of overhead feeders for the image classification task.

In a preferred embodiment, the present invention utilizes neural network explainability or interpretability tools to conduct misclassification analysis, identifying irrelevant objects within the dataset. These tools can be used to highlight, in the form of heatmaps, the image regions that maximally activate the classification output of the neural network. Users can discern the focus of neural network by interpreting the color gradient of the heatmap. In the application of vegetation encroachment detection, if a neural network is well-trained, regions containing vegetation and electrical equipment should be highlighted, while irrelevant regions such as roads and vehicles should be covered in cooler colors on the heatmap. Conversely, if a road or vehicle, or any other user-defined irrelevant object, is highlighted with warmer colors, it is an indication that the neural network is misfocused. These irrelevant objects are eliminated using a promptable pretrained model, with one or more of point prompts, text prompts, and mask prompts constructed based on the characteristics of the objects. This approach results in a distraction-free dataset that is used to retrain the image classification model, thereby enhancing its accuracy and efficiency.

In connection with a preferred methodology as disclosed herein, the deployment process of the trained deep learning models involves processing the collected footage to generate alerts and records. The system preferably synchronizes Global Positioning System (GPS) records with the imagery, applies adaptive frame sampling, and preprocesses the images. The final output includes frames annotated with vegetation encroachment warnings, GPS information, and timestamps, enabling maintenance teams to efficiently locate and address areas of concern.

### BRIEF DESCRIPTION OF THE DRAWINGS

FIG. 1 is a flow diagram of a method for deep learning-based automated detection of vegetation encroachment in overhead power distribution networks.

FIG. 2 is a flow diagram of the application of a promptable pretrained model to remove irrelevant objects from an image.

FIG. 3 is a flow diagram of the deployment of the trained deep learning models to process footage to generate alerts and reports.

FIG. 4 is a block diagram of a data processing system capable of implementing one or more embodiments of the present invention.

### DETAILED DESCRIPTION OF THE PREFERRED EMBODIMENTS

The present invention is generally directed to methods and systems for detecting vegetation encroachment. The methods and systems disclosed herein are applicable to a wide range of industries and field uses, although in a preferred embodiment, the preferred methods, system and system implementations disclosed herein are particularly applicable in and to detecting vegetation encroachment in overhead power transmission and distribution networks. In preferred embodiments the present invention, whether in methodologies and/or system implementation, utilizes neural network explainability tools for misclassification analysis to identify irrelevant objects in the vegetation encroachment dataset. Preferably, these objects are then removed using a promptable pretrained model, to construct a distraction-free dataset by generating point prompts, text prompts, and mask prompts based on the characteristics of the objects to be removed. The refined dataset is subsequently used to retrain the image classification model, significantly improving accuracy and efficiency.

In one embodiment, the present invention relates generally to a method for deep learning-based automated detection of vegetation encroachment in overhead power distribution networks, the method comprising:
capturing images or footage of overhead power distribution networks using one or more sensors;
synchronizing, by a processor, global positioning system (GPS) data with the captured images or footage to associate each image or frame with its geographical location;
preprocessing, by a processor, the captured images or frames to enhance quality and usability for deep learning analysis;
employing, by a processor, a deep learning model to detect vegetation encroachment in the preprocessed images or frames;
analyzing, by a processor, the output of deep learning explainability tools to identify irrelevant objects in the images that contribute to misclassification;
applying, by a processor, a promptable pretrained model to segment and remove identified irrelevant objects from the images;
retraining, by a processor, the deep learning model with the processed, irrelevant-object-free dataset to improve detection accuracy;
generating and outputting alerts, by a processor, GPS coordinates, and timestamps for images or frames where vegetation encroachment is detected.

In a preferred embodiment, the final output comprises annotated frames with vegetation encroachment warnings, along with corresponding latitude and longitude coordinates, timestamps, and metadata. This information can be stored in a centralized database for long-term record-keeping, integrated into GIS platforms to provide spatial context and facilitate visualization, and displayed on real-time dashboards for monitoring vegetation risks across the network. Additionally, these outputs can be processed further to generate predictive maintenance analytics, allowing utility companies to proactively address potential issues. The data can also be transferred to field crews via mobile or web applications, ensuring actionable insights are available for on-site inspections and remediation. Together, these capabilities enable efficient maintenance planning, reduce response times, and enhance the overall reliability and safety of power distribution networks.

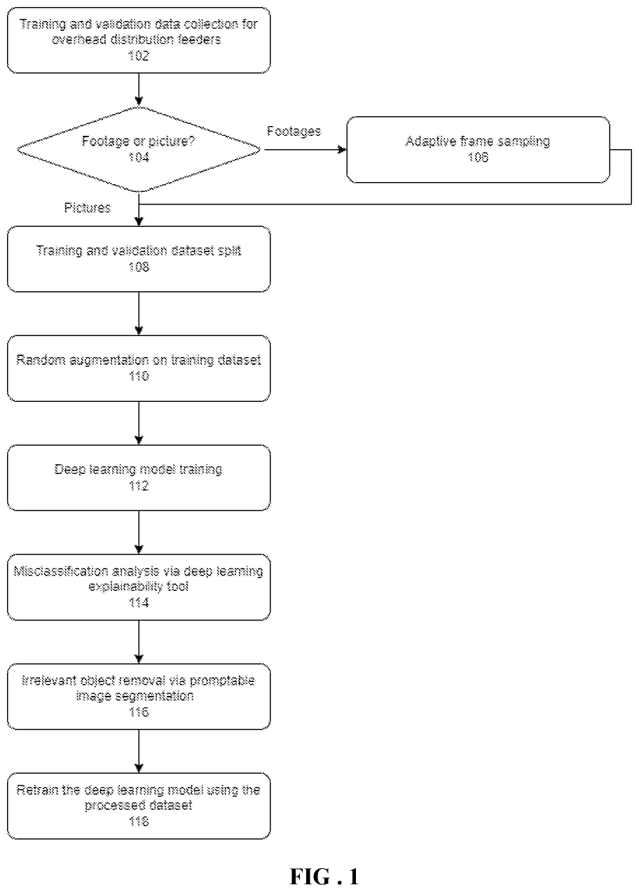

Referring first to FIG. 1, a method for deep learning-based automated detection of vegetation encroachment in overhead power distribution networks is shown. Block 102 represents the data collection stage. Data collection involves the use of various sensors to capture relevant footage and images. Examples of these sensors include, but are not limited to, street level sensors, sensors mounted to utility poles and other fixed structures, overhead sensors including aerial and satellite sensors, sensors mounted to movable platforms, which platforms may be capable of movement in one or more of an X, Y, and Z direction in a planar coordinate system, and vehicle mounted sensors. In one embodiment, one or more of the sensors are mounted to a vehicle that is capable of patrolling a desired route comprising, for example, overhead feeders, to capture relevant footage or images. Examples of such vehicles include, but are not limited to automobiles, trucks, motorcycles, all-terrain vehicles, drones, and other similar vehicles which may be manned or unmanned. The operator of the vehicle (either manned or unmanned) ensures that the vehicle traverses the desired route. In one embodiment, the desired route is preprogrammed and the vehicle traverses the programmed route. For example, the desired route may be contained in a navigation system such as a global positioning system which may be downloaded directly to the vehicle or to a personal computer or mobile telephone or other similar device of the operator.

Data for training and validation of the deep learning model can be collected from one or more sensors described herein. In one embodiment, the vehicle mounted sensors may include a variety of visual sensors mounted on a vehicle, such as those installed on the top, front windshield, and/or rear windshield of the vehicle.

The sensors may capture various data types, including, but not limited to, visual images, video, infrared (IR), LiDAR, RADAR, Sonar, multi-spectral, hyper-spectral, range finder data, global positioning system (GPS), longitude, latitude, weather data, including wind speed and ambient temperature, altitude, date, and time. The collected data may include both positive and negative examples for vegetation encroachment detection within the images.

In one embodiment, one or more of the visual sensors may have an adjustable field of view (FOV). For example, a wide angle (greater than 90 degrees) FOV enables image collection of nearby vegetation and the base of a power pole or tower. A medium or narrow field of view may enable high resolution imaging of vegetation, power lines, terrain and structures at a distance greater than the distance to the next power pole or tower, thus creating a system with greater coverage of all the power lines, structures, terrain and vegetation.

In one embodiment, one or more of the visual sensors comprises a digital camera or infrared or multi-spectral or hyper-spectral sensor. Multiple georeferenced aerial images of a right of way (ROW) can be acquired with specific overlap to be used with photogrammetric tools and techniques to produce colorized high density point cloud and surface mesh. The range or depth of an observed object may be interpolated based on the lens disparity of the stereoscopic camera system. In another embodiment, one or more of the sensors comprises a LiDAR sensor and optional digital camera to acquire georeferenced raw LiDAR data and optional photographs. In another embodiment, one or more of the sensors comprise a digital camera and range finder. In another embodiment one or more of the sensors comprises a range finder that is capable of scanning the horizontal plane of the maximum allowed tree height of the encroaching vegetation. These embodiments can be used in various combinations and in any or all of these embodiments the data is stored in local storage and/or upload to the cloud system for onsite or remote processing. The data transmission may be accomplished by one or more of local area network (LAN), personal area network (PAN), wide area network (WAN), wireless local area network (WLAN), metropolitan area network (MAN), IEEE 802.11x standards (i.e., Wi-Fi), IEEE 802.1x standards, and file transfer protocol (FTP).

The sensors may include general features and functions such as rechargeable battery systems with battery management sub systems to ensure long battery life, the sensor lens, one or more of active and passive visual or tactical sensors such as digital camera in the visible spectrum to acquire pictures and video, infrared (IR) camera, range finder, multi-spectral sensor, hyper-spectral sensor, LiDAR sensor, RADAR, Sonar, embedded microprocessor image processing engine, data storage such as hard drive, removable media storage, wireless antenna such as Wi-Fi, Bluetooth, cellular phone, wired data connection such as USB, Ethernet, RS232 serial communications, Modbus, CAN bus, analog or digital inputs or outputs and solar panel, to charge the battery system and waterproof rugged enclosure for year round outdoor use.

Block 104 classifies each captured data item from a visual sensor as either footage or a still image. The classification process is fully automated. The system analyzes the file extension of each captured data item to determine its type. Common video formats such as .mp4, .avi, and .mov are classified as videos, while common image formats like .jpg, .png, and .bmp are categorized as still images. For footage, Block 106 employs an adaptive sampling method to extract key and regular frames from the video stream. These key frames may include, for example, those highlighting utility assets, such as clear and unobstructed views of poles, transformers, insulators, and other critical infrastructure components. These frames are crucial as they provide reference points for identifying and assessing vegetation encroachment and evaluating the condition of the assets. Additionally, key frames may be captured during critical speed variations, such as moments of sudden acceleration, deceleration, or when the vehicle comes to a stop. By sampling frames at these variations, the system ensures comprehensive coverage of the visual scene across different motion states, improving the quality and representativeness of the extracted data for analysis. For regular sampling frames, if the user specifies a sampling frame rate, the system adheres to the user's preference. Otherwise, it extracts vehicle speed data associated with each frame from the footage metadata and samples frames proportionally to the speed to ensure sufficient information content in the extracted frames. The extracted key and regular frames and the originally captured images are combined to form the training and validation dataset for the deep learning model.

Block 108 utilizes a user-defined or automated training and validation split method to divide the dataset. A user-defined split allows for custom dataset division based on specific project criteria. Specific project criteria for a user-defined split may include, for example, geographical location, where the dataset is divided based on the region where the data was collected, such as urban vs. rural areas, to ensure the model performs well in different environments. Another example is seasonal variability, where data is split to include distinct seasons, such as summer/winter, to account for changes in vegetation density and appearance. Additionally, criteria can be based on data collection conditions, separating data captured under varying conditions such as daylight/nighttime, or clear/foggy weather, to improve model performance across diverse scenarios. Furthermore, the dataset can be split based on circuit reliability performance, focusing on areas with varying levels of reliability, such as high-performing vs. low-performing circuits, enabling the model to prioritize and address circuits with frequent vegetation-related issues. These tailored criteria allow for a more strategic dataset division, addressing specific project needs and enhancing model robustness.

Additionally, the system incorporates a variety of automated split methods, including but not limited to random splitting, stratified sampling, and cross-validation. Random splitting evenly distributes data instances across training and validation sets. Stratified sampling ensures proportional representation of data classes in both sets. Random and stratified sampling require a stratification ratio, e.g., 70%, or 75%, or 80%, or 85% for training to be specified. They also require a random seed to ensure reproducibility. Cross-validation employs iterative partitioning to enhance model robustness through multiple training and evaluation cycles, of which input parameters include the number of folds (i.e., equal sized subsets), for example, k-fold cross-validation, where k may be 3 or 4 or 5, etc., and the random seed for reproducibility.

Block 110 focuses on applying random image augmentation techniques to the training data prepared in Block 108. Image augmentation is a technique of altering the existing data to create additional data for the model training process. In other words, it is the process of artificially expanding the available dataset for training a deep learning model. Image augmentation techniques encompass geometric transformations such as flipping, rotating, shifting, scaling, cropping, blurring, noising (i.e., adding add noise to the image to allow the model to learn how to separate the signal from the noise in the image), and shearing; color space manipulations including brightness, contrast, saturation, and hue adjustments; noise addition like Gaussian noise to mimic real-world conditions; and feature space augmentations such as random erasing or cutout. This augmentation process aims to improve the generalization capabilities of the deep learning model and enhance its ability to handle imbalanced anomalies. Therefore, Block 110 manipulates the training images through the various methods including, but not limited to, rotating, flipping, shifting, scaling, translation, shearing, cropping, color jittering, adding noise, blurring, affine transformations, elastic deformations, cutout, random erasing, etc. Users can preset the magnitudes for each of these transformations and the number of transformations to apply each time the particular augmentation technique is used.

Each augmentation technique in Block 110 can be parameterized to control the intensity or frequency of its application, ensuring that the augmented dataset remains representative of real-world conditions without introducing unrealistic distortions. For example, rotations can be applied within a range of ±30 degrees to account for different orientations encountered in real scenarios, while horizontal and vertical flips may be randomly applied with a 50% probability per image to simulate various viewing perspectives. Shifting and translation can involve moving images horizontally or vertically by 10-20% of their dimensions, addressing positional variations, and scaling can resize images by factors ranging from 0.8× to 1.2×, enhancing the model's ability to generalize across size differences. Color jittering adjustments, such as brightness, contrast, saturation, and hue changes within ±20%, simulate diverse lighting conditions. Gaussian noise, with a mean of 0 and a standard deviation of 0.01-0.05, may be added to mimic sensor noise and environmental variability, while Gaussian blurs with kernel sizes of 3×3 or 5×5 pixels simulate motion blur or defocused captures. Elastic deformations, applied with grid spacing of 10 pixels and a distortion factor of 5, replicate natural distortions, and cutout or random erasing can obscure 10-20% of the image area, forcing the model to focus on global features. These parameterized transformations can be applied individually or in combination, with each image undergoing 2 to 4 transformations during a single augmentation cycle, depending on the user-defined probabilities. In addition the values of these parameterization transformations are only provided as examples of typical and suitable values. Other values would also be contemplated by one skilled in the art to ensure that the augmented dataset does not have any unrealistic distortions.

Block 112 leverages the prepared training data for training the deep learning model. This model can be a convolutional neural network (CNN) or an attention-based architecture designed for image classification. Standard image classification training techniques are employed, including transfer learning and learning rate scheduling. The model is trained for a binary classification task, where images with vegetation encroachment are classified as the positive class and images depicting normal conditions are classified as the negative class. Models are trained using an iterative process such as a stochastic gradient descent-type method to minimize a cross-entropy loss function. This iterative process involves feeding the model with training data, calculating the loss between the predicted output and the true label, followed by backward propagation to calculate the gradients of the loss with respect to the model parameters. These gradients are then used to update the parameters in the direction that reduces the loss. By repeatedly exposing the model to different training examples, the model learns to extract meaningful features from the data and make accurate predictions.

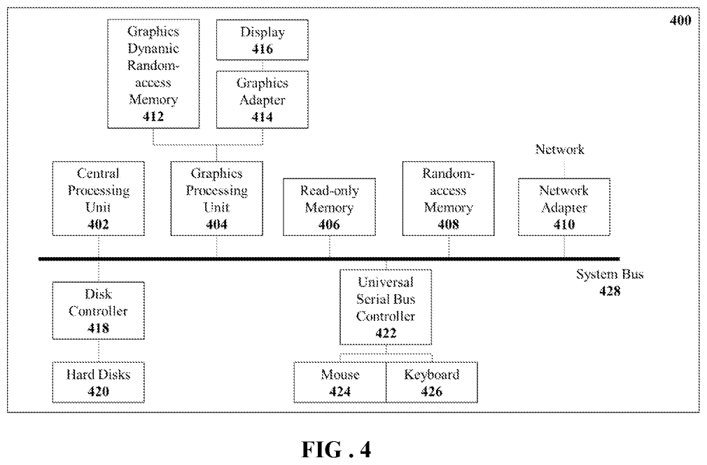

In some implementations, Block 112 includes a deep learning method training computing system communicatively coupled over a network. The deep learning method training computing system can be separate from the system 400 described in FIG. 4 or can be a portion of system 400. The deep learning method training computing system includes one or more processors and a memory. The one or more processors can be any suitable processing device (e.g., a processor core, a microprocessor, an ASIC, a FPGA, a controller, a microcontroller, etc.) and which processing device may constitute one processor or a plurality of processors that are operatively connected. The memory can include one or more non-transitory computer-readable storage mediums, such as RAM, ROM, EEPROM, EPROM, flash memory devices, magnetic disks, etc., and combinations thereof. The memory can store data and instructions which are executed by the processor to cause the training computing system to perform operations. In some implementations, the training computing system includes or is otherwise implemented by one or more server computing devices.

The deep learning method training computing system can include a model trainer that trains the machine-learned models stored at the deep learning method machine learning computing system using various training or learning techniques, such as, for example, backwards propagation. In particular, the model trainer can train a condition prediction model based on a set of training examples.

The model trainer includes computer logic utilized to provide desired functionality. The model trainer can be implemented in hardware, firmware, and/or software controlling a general purpose processor. For example, in some implementations, the model trainer includes program files stored on a storage device, loaded into a memory and executed by one or more processors. In other implementations, the model trainer includes one or more sets of computer-executable instructions that are stored in a tangible computer-readable storage medium such as RAM hard disk or optical or magnetic media.

The network can be any type of communications network, such as a local area network (e.g., intranet), wide area network (e.g., Internet), or some combination thereof and can include any number of wired or wireless links. In general, communication over the network can be carried via any type of wired and/or wireless connection, using a wide variety of communication protocols (e.g., TCP/IP, HTTP, SMTP, FTP, etc.), encodings or formats (e.g., HTML, XML, etc.), and/or protection schemes (e.g., VPN, secure HTTP, SSL, etc.).

Thus, the imagery platform, the training computing system, and the machine learning computing system may cooperatively operate to enable the user to select portions of imagery, instruct training of a model based on the selected training imagery, select additional imagery, and then instruct use of the trained model to receive predictions regarding structural assets depicted by the additionally selected imagery.

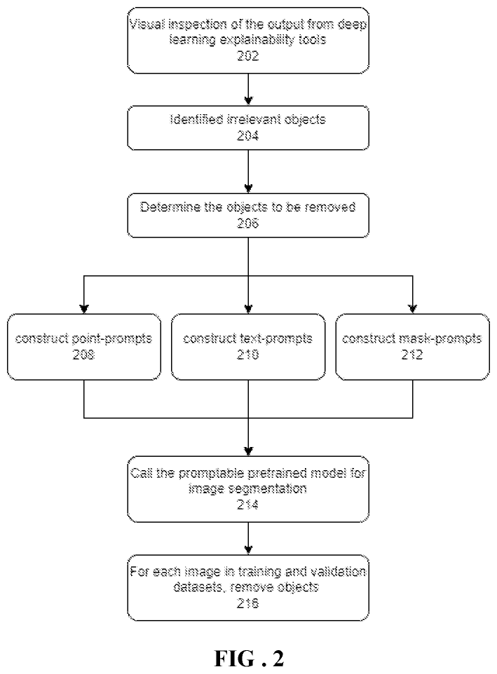

Blocks 114, 116, and 118 distinguish the invention described herein from standard deep learning training. The details will be provided later in the description of FIG. 2.

Block 114 employs a detailed analysis of misclassified samples during validation. Gradient-weighted Class Activation Mapping (Grad-CAM) or similar tools are utilized to pinpoint irrelevant objects in images that would tend to lead to incorrect predictions. These tools generate heatmaps to visually highlight the image regions that maximally activate the classification output of the neural network. For example, the heat map may use cooler colors (i.e., blues and greens) to indicate irrelevant areas such as roads and vehicles and use warmer colors (i.e., yellows, oranges, and reds) to indicate areas containing vegetation and electrical equipment. Users can interpret the color gradient of the heatmap to understand the focus of AI. In vegetation encroachment detection, a well-trained AI should highlight regions containing vegetation and electrical equipment, while suppressing activations in irrelevant areas like roads and vehicles. Conversely, if a road, vehicle, or any other user-defined irrelevant object is highlighted with warmer colors, it indicates that the neural network is misfocused. This analysis provides valuable insights into potential sources of error.

Based on the analysis result from Block 114, in Block 116 pre-trained image segmentation techniques including, but not limited to, Segment Anything Model (SAM), SAM 2, FastSAM, SAM-Lightening, and EfficientSAM are applied to both the training and validation datasets to remove irrelevant objects to prevent the interference in the judgment of the model.

Block 118 retrains the deep learning model from Block 112 using the processed, distractor-cleaned dataset. In contrast to the original dataset, the distractor-cleaned dataset has undergone distractor elimination. Within the 0-255 RGB color domain, the eliminated regions are filled with black pixels (0, 0, 0). These eliminated regions may include features such as vehicles, pedestrians, road signs, buildings, sky and clouds, ground features like roads or sidewalks, animals, human-made structures such as fences or light posts, debris, reflections or glare, shadowed regions, temporary objects like bicycles or drones, and camera artifacts such as lens flares or smudges, all of which provide no relevant information for vegetation encroachment detection.

Given that distractors offer no benefit to the vegetation encroachment task, their removal facilitates more efficient AI model training, faster convergence, stronger generalization capabilities, and accelerated inference. AI models are retrained using a stochastic gradient descent method to minimize cross-entropy loss. This involves feeding the model batches of data from the distractor-cleaned dataset in each iteration. For each batch, the model calculates the difference between its predicted output and the correct labels, and then adjusts its parameters to reduce this error. This adjustment is based on the gradient of the loss function with respect to the parameters, computed through backpropagation.

FIG. 2 is a flow diagram illustrating the process by which a user-promptable pretrained model is applied to remove irrelevant objects from an image. A user-promptable pretrained model refers to a pre-trained AI model that can be guided or directed by specific user inputs, including text prompts, masks, and points.

Text prompts provide a natural language interface for users to specify the desired object or region of interest.

Masks define the specific area of the image that the model should focus on, allowing for more precise control over the segmentation results.

Points are typically provided as 2D coordinates and are often grouped into a multidimensional tuple, where each element represents a specific point. This structure allows users to precisely specify multiple regions of interest within an image.

Block 202 represents the stage of visual inspection using deep learning explainability tools. This step involves the examination of the output generated by explainability tools to identify potential irrelevant objects in the images. For instance, a gradient-weighted class activation map (Grad-CAM) can be utilized to produce heatmaps that highlight areas of the image contributing most to the prediction. These predictions are used to indicate the importance of each pixel in relation to the prediction by increasing or decreasing the intensity of the pixel. By analyzing these heatmaps, areas with high activation that correspond to irrelevant objects can be visually identified. This allows for a targeted approach in determining which specific elements in the image may be causing incorrect predictions by the model, thereby facilitating the subsequent steps of object removal.

Block 204 categorizes objects as either relevant or irrelevant to the task of vegetation encroachment. During this step, the objects in the images that do not contribute to the intended task are identified based on the analysis. As discussed above, in the context of vegetation encroachment, the primary elements of interest are power lines, poles, electrical equipment, and vegetation. However, images captured often depict street scenes that include objects such as roads, sky, traffic lights, cars, buildings, and other elements that are typically unrelated to vegetation encroachment. Given that the image classification task involves two categories—one for vegetation encroachment and the other for normal conditions—it is expected that the AI model learns to recognize the features associated with vegetation encroaching on power lines, poles, and electrical equipment. A convolutional neural network (CNN) can be employed to extract discriminative image features. The CNN comprises convolutional layers that apply filters to input images, generating feature maps that capture image patterns. In the context of vegetation encroachment, the CNN learns to identify features such as textural disparities between vegetation and infrastructure, chromatic variations indicative of vegetation versus non-vegetation, and shape dissimilarities between organic and man-made objects. For the normal condition category, however, the diversity of scenes poses a challenge. There are no specific, explicit features for the AI to learn for this category, leading to potential misclassifications. The AI might incorrectly interpret the presence of roads, sky, traffic lights, cars, and buildings as indicative of the normal condition category, thereby making erroneous judgments. As a result, these elements are considered irrelevant objects that need to be identified and removed to improve the accuracy of the model.

Block 206 determines the specific objects that need to be removed. Given the large number of irrelevant objects, the frequency of each irrelevant object's occurrence in the validation dataset is calculated. Users can set a predefined threshold for each irrelevant object, and only those irrelevant objects whose frequency exceeds this threshold will be considered for removal. This approach ensures that only the most frequently occurring irrelevant objects, which are likely to have the most significant impact on model performance, are targeted for removal.

Block 208, Block 210, and Block 212 are preparatory steps for utilizing the promptable pretrained model for image segmentation in Block 214. A promptable pretrained model is defined herein as a model that can accept various types of prompts to perform specific tasks. Examples of such models include the SAM and the FastSAM.

In the context of the promptable pretrained model, point-prompts 208 are specific points marked on the image indicating the locations of the objects to be segmented. These points help the model understand exactly which areas of the image are of interest and should be segmented out. For example, for images captured from vehicle-mounted sensors, point-prompts are particularly suitable for segmenting roads, as Block 102 captures street scene images, and in the full view of a vehicle, roads are often located centrally and towards the bottom of the image. For aerial images captured from satellites and other similar sources, point prompts may be used for segmenting sky that can be located central and towards the top of the image. This prior knowledge can be used to construct point-prompts. For example, the dimensions of the image (L, W) are first obtained, where L is the length and W is the width. Then, three points located at (0.9L, 0.3W), (0.9L, 0.5W), and (0.9L, 0.6W) can be selected as point-prompts for road segmentation.

Text-prompts 210 are descriptive phrases or sentences provided by a user to the model to specify the objects to be segmented. For instance, a text-prompt might describe the object as “a red truck”, a “brown building”, “a white car”, etc. enabling the model to identify and segment objects that match this description from the image. Text-prompts are particularly suitable for identifying irrelevant objects whose locations in the image are not fixed, such as buildings, vehicles, and other objects that can appear anywhere within the scene.

Mask prompts 212 are used by first leveraging pretrained instance segmentation models to generate masks for the irrelevant objects. These masks are then fed as mask prompts into SAM. Mask prompts are suitable for scenarios where pretrained instance segmentation models are available.

Block 214 utilizes the promptable pretrained model for image segmentation. Pretrained instance segmentation models, such as the Segment Anything Model (SAM), are utilized to accept the constructed prompts and perform the segmentation to remove the irrelevant objects.

Block 216 processes each image in the training and validation datasets 108 by removing the identified irrelevant objects. This step ensures that the datasets are cleansed of distractions, thereby enhancing the performance of the deep learning model.

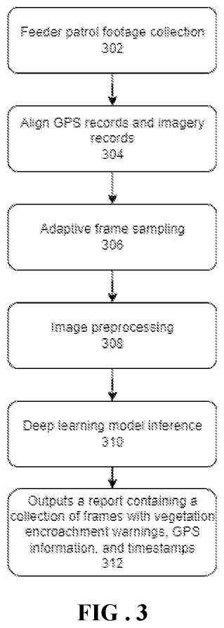

FIG. 3 is a flowchart illustrating the deployment of trained deep learning models to process footage and generate alerts and records. The processed and distractor-cleaned datasets from FIG. 2 serve as a foundation for the model deployment pipeline illustrated in FIG. 3. Once trained on the cleaned datasets, the deep learning model achieves higher precision and generalization capabilities. During deployment as shown in FIG. 3, the trained model is applied to new feeder patrol footage.

Block 302 represents the data collection stage. The data collection involves for example, operating a vehicle equipped with various sensors to patrol overhead feeders and capture relevant footage or images. These sensors may include, but are not limited to, high-resolution cameras, infrared sensors, LiDAR, and GPS devices. The vehicle traverses predetermined routes to ensure comprehensive coverage of the feeders, capturing continuous footage that can later be analyzed for vegetation encroachment. As discussed above, data may also be collected from mounted street level sensors, sensors mounted to utility poles and other fixed structures, overhead sensors including aerial and satellite sensors, and sensors mounted to movable platforms, which platforms may be movable in one or more of X, Y and Z directions in a planar coordinate system.

Block 304 aligns GPS records with imagery records. This synchronization step matches each frame of the captured footage with precise GPS data, ensuring accurate location tracking. By correlating the spatial data with the imagery, the system can pinpoint the exact geographical position of any detected vegetation encroachment, facilitating targeted maintenance actions. In instances where the GPS data recording frequency differs from the footage frames per second (fps), this synchronization becomes crucial. For example, if the GPS data recording frequency is 10 data points per second while the footage feet per second (fps) is 30, and the user-selected analysis frequency is one frame per second, alignment is necessary.

The specific approach to align GPS records with imagery records involves the following steps:
1. Interpolation of GPS Data: Given the discrepancy between GPS data points and the footage frames, interpolation is used to generate a continuous GPS track. This process estimates the intermediate GPS coordinates for each frame by using the existing GPS data points. Linear interpolation is often employed, where the coordinates for the frames between two recorded GPS points are calculated based on their relative positions in time.
2. Time-Stamp Matching: Each frame of the footage and each GPS data point carries a timestamp. These timestamps are used to align the data. The system matches each frame to the nearest GPS data point in time. If the timestamps do not perfectly match, the system uses the interpolated GPS data to provide an accurate location for each frame.
3. Frame Selection Based on User Preferences: The corresponding interpolated GPS data points are then matched to these selected frames.

In addition to Steps 1 to 3 outlined above, one or more of the following steps may also be performed to further align the GPS records with the imagery records:
1. Error Correction and Smoothing of GPS Data: Before any alignment, the raw GPS data may be analyzed for anomalies such as noise, signal loss, or inconsistencies, which can occur in areas with poor satellite reception. Techniques such as Kalman filtering or moving average smoothing can be applied to stabilize and correct GPS tracks, ensuring a reliable basis for subsequent processing.
2. GPS Coordinate Transformation: If the GPS data is recorded in a coordinate reference system (e.g., WGS84 or UTM) that differs from the desired format, a transformation step is applied to maintain consistency in geospatial representation.
3. Integration with External Sensors (if available): Data from additional sensors, including, for example, accelerometers, gyroscopes, or LiDAR can be integrated into the synchronization process. For example, LiDAR-derived distances can enhance spatial accuracy by providing 3D context for detected encroachments and refining the GPS tracks.
4. Interpolation of GPS Data: With corrected and transformed GPS data, interpolation can be performed to generate a continuous GPS track. Using techniques such as linear interpolation, the system estimates intermediate GPS coordinates to align with each frame of the captured footage based on their relative positions in time.
5. Timestamp Matching and Synchronization Calibration: Using the timestamps associated with both GPS data points and imagery frames, the system aligns each frame with the nearest GPS data point. If timestamp discrepancies occur due to system clock drift, a synchronization calibration step adjusts for these mismatches, ensuring precise temporal alignment.
6. Geospatial Alignment Validation: To verify the accuracy of the alignment, the synchronized GPS coordinates can be cross-checked against known landmarks, map layers, or GIS data. This step helps to validate and adjust alignment accuracy, especially in complex terrains or areas with dense vegetation.
7. Frame Selection Based on User Preferences: The user-selected analysis frequency determines the subset of frames to be used (e.g., one frame per second). The corresponding interpolated GPS data points are then matched to these selected frames to maintain spatial and temporal consistency.
8. Multi-Frame Location Estimation: For frames where GPS data overlaps across consecutive timestamps, averaging or blending the GPS coordinates from multiple frames refines the spatial estimate, reducing noise and improving detection accuracy.
9. Final Synchronization Output: The processed and validated GPS coordinates can be aligned with each selected frame, ensuring precise location tracking for detected vegetation encroachments. The final synchronized dataset is now optimized for targeted maintenance actions and further analysis.

Block 306 employs adaptive frame sampling. This method involves analyzing the video stream to extract key frames based on specific criteria, such as, for example, changes in scene content, motion detection, or predefined time intervals. If the user specifies a sampling frame rate, the system adheres to the user's preference. For example, if the user specifies an analysis frequency of one frame per second, the system selects every 30th frame from the footage (given a 30 fps footage rate) for analysis. Otherwise, the system dynamically adjusts the sampling rate based on data (e.g., vehicle speed data) extracted from the footage metadata. In the case of vehicle mounted sensors, frames may be sampled proportionally to the vehicle's speed.

Block 308 involves image preprocessing. This step includes the use of several techniques to enhance the quality and usability of the images, including image resizing and normalization, among others. Image resizing adjusts the dimensions to a standardized format suitable for the deep learning model. Normalization scales pixel values to a consistent range, improving model performance and convergence. Additional preprocessing steps may also be utilized including, but not limited to, irrelevant object removal 214, contrast adjustment, color correction, and histogram equalization to further improve image quality by way of example and not limitation.

Block 310 leverages the deep learning model for inference. The preprocessed images, which may have undergone the object removal process described in FIG. 2, are fed into the trained deep learning model (Block 118) designed to detect and analyze vegetation encroachment. This step ties back to the earlier processes in FIG. 2, as the quality improvements made during object removal directly enhance the precision, generalization capabilities, and reliability of the deep learning model during deployment. The model may utilize advanced architectures such as CNNs or attention-based mechanisms to accurately classify and localize encroaching vegetation. The inference process can determine the presence, confidence score, and severity of vegetation encroachment in each frame.

Block 312 outputs a report or database containing a collection of frames with vegetation encroachment warnings, GPS information, and timestamps. This final step generates the processed output, where each frame identified with vegetation encroachment is annotated with a warning label and confidence score. The associated GPS coordinates and timestamps are embedded into the metadata, providing a comprehensive and actionable dataset.

This data may be stored in a centralized database for long-term record-keeping, integrated into GIS platforms to provide spatial context and facilitate visualization, and displayed on real-time dashboards for monitoring vegetation risks across the network. Additionally, these outputs can be processed further to generate predictive maintenance analytics, allowing utility companies to proactively address potential issues. The data can also be transferred to field crews via mobile or web applications, ensuring actionable insights are available for on-site inspections and remediation. In one embodiment, this data set may be exported to a computer/system of a maintenance team. Based thereon, this information enables maintenance teams to efficiently locate and address areas of concern, ensuring the reliability and safety of the overhead power distribution network. The output can also be formatted into reports, visual dashboards, or integrated into geographic information systems (GIS) for further analysis and planning.

Block 312 may also include the locations of the vegetation relative to the locations of the electrical power lines and the specific types of the vegetation to generate a predicted timing of encroachment of the electrical power lines by the vegetation to identify future encroachment areas. Identification of the specific types of vegetation can be used to indicate the types of maintenance that should be performed. For example if certain trees are known to be infected with a pest that weakens the structure of the tree, making it more susceptible to breaking or falling, the trees can be marked for further observation.

Block 312 may also include a vegetative modeler, including an image analyzer and at least one 3-dimensional (3D) vegetation growth model for analyzing images of vegetation that is growing around electrical power lines of the electric utility including identifying locations of the vegetation relative to locations of the electrical power lines and to identify specific types of the vegetation. The vegetative modeler may include regional models and 3D vegetation growth prediction models for the vegetation that utilizes weather models which are provided by prediction models including weather prediction models as described below.

Block 312 may also include a scheduler. Vegetation maintenance prioritization can be ranked in terms of priority for the deemed most critical customers (e.g., hospitals, public safety and governmental offices) served and the number customers associated with specific distribution paths. The scheduler can rank relative outage impacts.

FIG. 4 depicts an embodiment of a data processing system 400. In this embodiment, the system 400 includes one or more central processing units (CPUs) 402 and one or more graphics processing units (GPUs) 404. In one or more embodiments, each CPU 402 may include a reduced instruction set computer microprocessor and may contain components such as an arithmetic logic unit, control unit, and various registers that handle basic computation and control tasks within the system. The one or more CPUs 402 and the one or more GPUs 404 may be connected to one or more computer readable storage mediums, such as read-only memory 406 or random access memory 408.

The computer readable storage medium can be a tangible device that can retain and store instructions for use by an instruction execution device. The computer readable storage may be, for example, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of any of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

GPUs 404 are highly suitable for training deep learning models due to their parallel processing capabilities, which allow them to handle multiple operations simultaneously. They are designed to manage and transform memory efficiently, accelerating tasks that involve large-scale matrix and vector operations, which are common in deep learning. Additionally, their architecture enables them to process vast amounts of data concurrently, significantly reducing the time required for training complex models.

The system 400 comprises various memory components including computer readable storage medium such as read-only memory (ROM) 406 and random-access memory (RAM) 408. The ROM 406 is connected to the system bus 428 and may contain a basic input/output system that manages certain fundamental functions of system 400, while the RAM 408 serves as temporary data storage during processing activities.

Graphics Dynamic random-access memory (DRAM) 412, a critical component for graphics processing, provides high-speed data storage and retrieval necessary for rendering images. It temporarily holds the data being processed by the GPU, enabling rapid access and manipulation of graphics data, which is essential for maintaining smooth and efficient graphics performance.

A network adapter 410 links bus 428 with an external network, enabling the data processing system 400 to communicate with other similar systems. A graphics display 416 is connected to the system bus 428 via a graphics adapter 414 and graphics dynamic random-access memory 412, which together enhance the performance of graphics-intensive applications.

The system 400 also includes an input/output (I/O) adapter in the form of a disk controller 418 that interfaces with hard disks 420. Additionally, the system features a Universal Serial Bus (USB) controller 422 to handle USB-connected peripherals such as a mouse 424 and a keyboard 426.

Thus, as illustrated in FIG. 4, the system 400 encompasses processing capabilities through one or more CPUs 402 and one or more GPUs 404, computer readable storage medium including ROM 406 and RAM 408, input devices such as the mouse 424 and keyboard 426, and output devices including the graphics display 416. All components are interconnected via the system bus 428, ensuring efficient data transfer and communication within the system. In one embodiment, the present invention also relates generally to a non-transitory computer-readable medium storing instructions that are operable, when executed by one or more computers, to cause the one or more computers to perform operations comprising:
a. synchronizing GPS data received from at least one GPS device with captured images or footage to accurately associate each image or frame with its geographical location;
b. preprocessing the captured images or frames to enhance quality and usability for deep learning analysis;
c. employing a deep learning model to detect vegetation encroachment in the preprocessed images or frames;
d. analyzing the output of deep learning explainability tools to identify irrelevant objects in the images that contribute to misclassification;
e. applying a promptable pretrained model to segment and remove identified irrelevant objects from the images;
f. retraining the deep learning model with the processed, irrelevant-object-free dataset to improve detection accuracy; and
g. generating and outputting alerts, GPS coordinates, and timestamps for images or frames where vegetation encroachment is detected.

In one embodiment, the present invention also relates generally to a method for training and validating a deep learning model for deep learning-based automated detection of vegetation encroachment in overhead power distribution networks, the method comprising:
a. capturing images and frames using one or more visual sensors in a defined area of a power distribution system, wherein the one or more visual sensors comprise street level sensors, sensors mounted to utility poles and other fixed structures, aerial sensors, satellite sensors, sensors mounted to movable platforms and vehicle sensors, wherein the captured images and frames comprise a data set for training and validating a deep learning model;
b. preprocessing the captured images or frames to enhance quality and usability for deep learning analysis;
c. applying random image augmentation techniques to the data set to expand the data set;
d. training the deep leaning model with the data set using an iterative process;
e. categorizing objects in the captured images and frames as either relevant or irrelevant to vegetation encroachment;
f. analyzing the output of deep learning explainability tools to identify irrelevant objects in the images and frames that contribute to misclassification;
g. applying a promptable pretrained model to segment and remove identified irrelevant objects from the images; and
h. retraining the deep learning model with the processed, irrelevant-object-free dataset to improve detection accuracy.

More generally, computer readable program instructions can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Finally, while the invention described herein is directed to the detection of vegetation encroachment in power distribution networks, it is also contemplated that the invention described herein may also be used for the detection of vegetation encroachment in power transmission networks. That is, the neural network explainability or interpretation tools may be used to identify irrelevant regions or objects, although these regions or objects may be different in some way from the irrelevant regions or objects identified in a power distribution network.

It will thus be seen that the objectives set forth above, among those made apparent from the preceding disclosure, can be and are efficiently attained. It is also intended that all matter contained in the above disclosure or shown in the accompanying drawings shall be interpreted as illustrative and not in a limiting sense. Other advantages and objectives are also deemed to be apparent from the disclosure herein. It thus should also be appreciated that the present invention can be implemented and utilized in numerous ways. And also, while the present invention has been disclosed with respect to preferred embodiments, those skilled in the art will readily appreciate that various changes and/or modifications can be made to the invention without departing from the spirit or scope of the invention.

### Additional Embodiments

Clause 1. A method for deep learning-based automated detection of vegetation encroachment in overhead power distribution networks, the method comprising:
   capturing images or footage of overhead power distribution networks using one or more sensors;
   synchronizing, by a processor, global positioning system (GPS) data with the captured images or footage to associate each image or frame with its geographical location;
   preprocessing, by a processor, the captured images or frames to enhance quality and usability for deep learning analysis;
   employing, by a processor, a deep learning model to detect vegetation encroachment in the preprocessed images or frames;
   analyzing, by a processor, the output of deep learning explainability tools to identify irrelevant objects in the images that contribute to misclassification;
   applying, by a processor, a promptable pretrained model to segment and remove identified irrelevant objects from the images;
   retraining, by a processor, the deep learning model with the processed, irrelevant-object-free dataset to improve detection accuracy;
   generating and outputting alerts, by a processor, GPS coordinates, and timestamps for images or frames where vegetation encroachment is detected.
Clause 2. The method according to Clause 1, wherein the one or more sensors are selected from the group consisting of street level sensors, sensors mounted to utility poles and other fixed structures, overhead sensors including aerial and satellite sensors, sensors mounted to movable platforms capable of movement in one or more of an X, Y, and Z direction in a planar coordinate system, vehicle mounted sensors, and combination of one or more of the foregoing.
Clause 3. The method according to Clause 1 or Clause 2, wherein one or more of the sensors are mounted on a vehicle.
Clause 4. The method of Clause 2 or Clause 3, wherein the one or more sensors comprise visual sensors include one or more of high-resolution cameras, infrared sensors, LiDAR, and GPS devices.
Clause 5. The method of any of Clauses 1 to 4, wherein preprocessing the captured images includes steps of one or more of image resizing, normalization, contrast adjustment, color correction, histogram equalization, and irrelevant object removal.
Clause 6. The method of any of Clauses 1 to 5, wherein the deep learning model is a convolutional neural network or an attention-based architecture designed for image classification.
Clause 7. The method of any of Clauses 1 to 6, wherein the deep learning model employs standard image classification techniques, including transfer learning and learning rate scheduling.
Clause 8. The method of any of the preceding Clauses, wherein the promptable pretrained model accepts point-prompts, text-prompts, and mask prompts for image segmentation.
Clause 9. The method of any of the preceding Clauses, wherein the analysis of deep learning explainability tools utilizes Gradient-weighted Class Activation Mapping or similar tools to pinpoint irrelevant objects in images.
Clause 10. The method of any of the preceding Clauses, further comprising applying adaptive frame sampling to extract key frames from the video footage based on vehicle speed and user-defined sampling rates.
Clause 11. The method according to Clause 10, wherein the key frames comprise one or more of changes in scene content, motion detection, and predefined time intervals.
Clause 12. The method of any of the preceding Clauses, wherein the output includes frames annotated with vegetation encroachment warnings, GPS coordinates, and timestamps, the method further comprising the step of formatting the output into reports or integrating the output into geographic information systems for further analysis.
Clause 13. The method of any of the preceding Clauses, further comprising the step of using one or more random image augmentation techniques to improve the generalization capabilities of the deep learning model.
Clause 14. The method according to Clause 13, wherein the one or more random image augmentation techniques are selected from the group consisting of flipping, rotating, shifting, scaling, translation, cropping, color jittering, blurring, noising, affine transformations, elastic deformations, cutout, random erasing, shearing and combinations of the foregoing.
Clause 15. The method according to Clause 1, wherein the step of synchronizing GPS data with the captured image or footage to associate each image with its geographical location comprises the following steps:
   a. interpolating GPS data to generate a continuous GPS track; and
   b. matching each time-stamp to the nearest data point in time.
Clause 16. The method according to Clause 15, wherein the step of synchronizing GPS data further comprises one or more of the following:
   a. analyzing the raw GPS data for anomalies prior to step a.;
   b. transforming GPS data into a desired format;
   c. integrating data from additional sensors;
   d. cross checking synchronized GPS coordinates against known landmarks, map layers or GAS data; and
   e. averaging or blending GPS coordinates from multiple frames where GPS data overlaps across consecutive timestamps.
Clause 17. The method according to Clause 1, wherein one or more of the steps is carried out by at least one processor.
Clause 18. A computer implemented method for deep learning-based automated detection of vegetation encroachment in overhead power distribution networks, the method comprising:
   capturing images or footage of overhead power distribution networks using one or more sensors;
   using at least one processor, synchronizing GPS data received from at least one GPS device with the captured images or footage to accurately associate each image or frame with its geographical location;
   using the at least one processor, preprocessing the captured images or frames to enhance quality and usability for deep learning analysis;
   employing a deep learning model using the at least one processor to detect vegetation encroachment in the preprocessed images or frames;
   analyzing the output of deep learning explainability tools using the at least one processor to identify irrelevant objects in the images that contribute to misclassification;
   applying a promptable pretrained model using the at least one processor to segment and remove identified irrelevant objects from the images;
   using the at least one processor, retraining the deep learning model with the processed, irrelevant-object-free dataset to improve detection accuracy;
   generating and outputting alerts, GPS coordinates, and timestamps for images or frames where vegetation encroachment is detected.
Clause 19. A non-transitory computer-readable medium storing instructions that are operable, when executed by one or more computers, to cause the one or more computers to perform operations comprising:
   a. synchronizing GPS data received from at least one GPS device with captured images or footage to accurately associate each image or frame with its geographical location;
   b. preprocessing the captured images or frames to enhance quality and usability for deep learning analysis;
   c. employing a deep learning model to detect vegetation encroachment in the preprocessed images or frames;
   d. analyzing the output of deep learning explainability tools to identify irrelevant objects in the images that contribute to misclassification;
   e. applying a promptable pretrained model to segment and remove identified irrelevant objects from the images;
   f. retraining the deep learning model with the processed, irrelevant-object-free dataset to improve detection accuracy; and
   g. generating and outputting alerts, GPS coordinates, and timestamps for images or frames where vegetation encroachment is detected.
Clause 20. A method for training and validating a deep learning model for deep learning-based automated detection of vegetation encroachment in overhead power distribution networks, the method comprising:
   a. preparing a training data set for training a deep learning model by:
      i. capturing images and frames using one or more visual sensors in a defined area of a power distribution system, wherein the one or more visual sensors comprise street level sensors, sensors mounted to utility poles and other fixed structures, aerial sensors, satellite sensors, sensors mounted to movable platforms and vehicle sensors;
      ii. preprocessing the captured images or frames to enhance quality and usability for deep learning analysis; and
      iii. applying random image augmentation techniques to the data set to expand the data set;
   b. training the deep leaning model with the training data set using an iterative process;
   c. categorizing objects in the captured images and frames as either relevant or irrelevant to vegetation encroachment and analyzing the output of deep learning explainability tools to identify irrelevant objects in the images and frames that contribute to misclassification;
   d. applying a promptable pretrained model to segment and remove identified irrelevant objects from the images; and
   e. retraining the deep learning model with the processed, irrelevant-object-free dataset to improve detection accuracy.
Clause 21. The method of Clause 20, wherein the deep learning model comprises a convolutional neural network or an attention-based architecture designed for image classification.
Clause 22. The method of Clause 20 or Clause 21, wherein step of training the deep learning model with the training data set comprise a training computing system comprising one or more processors and a memory, wherein the memory can store data and instructions which are executed by the processor to cause the training computing system to perform operations.

What is claimed is:

1. A method for deep learning-based automated detection of vegetation encroachment in overhead power distribution networks, the method comprising:
capturing images or footage of overhead power distribution networks using one or more sensors;
synchronizing, by a processor, global positioning system (GPS) data with the captured images or footage to associate each image or frame with its geographical location;
preprocessing, by a processor, the captured images or frames to enhance quality and usability for deep learning analysis;
employing, by a processor, a deep learning model to detect vegetation encroachment in the preprocessed images or frames;
analyzing, by a processor, the output of deep learning explainability tools to identify irrelevant objects in the images that contribute to misclassification;
applying, by a processor, a promptable pretrained model to segment and remove identified irrelevant objects from the images;
retraining, by a processor, the deep learning model with the processed, irrelevant-object-free dataset to improve detection accuracy;
generating and outputting alerts, by a processor, GPS coordinates, and timestamps for images or frames where vegetation encroachment is detected.

2. The method according to claim 1, wherein the one or more sensors are selected from the group consisting of street level sensors, sensors mounted to utility poles and other fixed structures, overhead sensors including aerial and satellite sensors, sensors mounted to movable platforms capable of movement in one or more of an X, Y, and Z direction in a planar coordinate system, vehicle mounted sensors, and combination of one or more of the foregoing.

3. The method according to claim 1, wherein one or more of the sensors are mounted on a vehicle.

4. The method of claim 2, wherein the one or more sensors comprise visual sensors include one or more of high-resolution cameras, infrared sensors, LiDAR, and GPS devices.

5. The method of claim 1, wherein preprocessing the captured images includes steps of one or more of image resizing, normalization, contrast adjustment, color correction, histogram equalization, and irrelevant object removal.

6. The method of claim 1, wherein the deep learning model is a convolutional neural network or an attention-based architecture designed for image classification.

7. The method of claim 1, wherein the deep learning model employs standard image classification techniques, including transfer learning and learning rate scheduling.

8. The method of claim 1, wherein the promptable pretrained model accepts point-prompts, text-prompts, and mask prompts for image segmentation.

9. The method of claim 1, wherein the analysis of deep learning explainability tools utilizes Gradient-weighted Class Activation Mapping or similar tools to pinpoint irrelevant objects in images.

10. The method of claim 1, further comprising applying adaptive frame sampling to extract key frames from the video footage based on vehicle speed and user-defined sampling rates.

11. The method according to claim 10, wherein the key frames comprise one or more of changes in scene content, motion detection, and predefined time intervals.

12. The method of claim 1, wherein the output includes frames annotated with vegetation encroachment warnings, GPS coordinates, and timestamps, the method further comprising the step of formatting the output into reports or integrating the output into geographic information systems for further analysis.

13. The method of claim 1, further comprising the step of using one or more random image augmentation techniques to improve the generalization capabilities of the deep learning model.

14. The method according to claim 13, wherein the one or more random image augmentation techniques are selected from the group consisting of flipping, rotating, shifting, scaling, translation, cropping, color jittering, blurring, noising, affine transformations, elastic deformations, cutout, random erasing, shearing and combinations of the foregoing.

15. The method according to claim 1, wherein the step of synchronizing GPS data with the captured image or footage to associate each image with its geographical location comprises the following steps:
a. interpolating GPS data to generate a continuous GPS track; and
b. matching each time-stamp to the nearest data point in time.

16. The method according to claim 15, wherein the step of synchronizing GPS data further comprises one or more of the following:
a. analyzing the raw GPS data for anomalies prior to step a.;
b. transforming GPS data into a desired format;
c. integrating data from additional sensors;
d. cross checking synchronized GPS coordinates against known landmarks, map layers or GAS data; and
e. averaging or blending GPS coordinates from multiple frames where GPS data overlaps across consecutive timestamps.

17. The method according to claim 1, wherein one or more of the steps is carried out by at least one processor.

18. A computer implemented method for deep learning-based automated detection of vegetation encroachment in overhead power distribution networks, the method comprising:
capturing images or footage of overhead power distribution networks using one or more sensors;
using at least one processor, synchronizing GPS data received from at least one GPS device with the captured images or footage to accurately associate each image or frame with its geographical location;
using the at least one processor, preprocessing the captured images or frames to enhance quality and usability for deep learning analysis;
employing a deep learning model using the at least one processor to detect vegetation encroachment in the preprocessed images or frames;
analyzing the output of deep learning explainability tools using the at least one processor to identify irrelevant objects in the images that contribute to misclassification;
applying a promptable pretrained model using the at least one processor to segment and remove identified irrelevant objects from the images;
using the at least one processor, retraining the deep learning model with the processed, irrelevant-object-free dataset to improve detection accuracy;
generating and outputting alerts, GPS coordinates, and timestamps for images or frames where vegetation encroachment is detected.

19. A non-transitory computer-readable medium storing instructions that are operable, when executed by one or more computers, to cause the one or more computers to perform operations comprising:
a. synchronizing GPS data received from at least one GPS device with captured images or footage to accurately associate each image or frame with its geographical location;
b. preprocessing the captured images or frames to enhance quality and usability for deep learning analysis;
c. employing a deep learning model to detect vegetation encroachment in the preprocessed images or frames;
d. analyzing the output of deep learning explainability tools to identify irrelevant objects in the images that contribute to misclassification;
e. applying a promptable pretrained model to segment and remove identified irrelevant objects from the images;
f. retraining the deep learning model with the processed, irrelevant-object-free dataset to improve detection accuracy; and
g. generating and outputting alerts, GPS coordinates, and timestamps for images or frames where vegetation encroachment is detected.

20. A method for training and validating a deep learning model for deep learning-based automated detection of vegetation encroachment in overhead power distribution networks, the method comprising:
a. preparing a training data set for training a deep learning model by:
i. capturing images and frames using one or more visual sensors in a defined area of a power distribution system, wherein the one or more visual sensors comprise street level sensors, sensors mounted to utility poles and other fixed structures, aerial sensors, satellite sensors, sensors mounted to movable platforms and vehicle sensors;
ii. preprocessing the captured images or frames to enhance quality and usability for deep learning analysis; and
iii. applying random image augmentation techniques to the data set to expand the data set;
b. training the deep leaning model with the training data set using an iterative process;
c. categorizing objects in the captured images and frames as either relevant or irrelevant to vegetation encroachment and analyzing the output of deep learning explainability tools to identify irrelevant objects in the images and frames that contribute to misclassification;
d. applying a promptable pretrained model to segment and remove identified irrelevant objects from the images; and
e. retraining the deep learning model with the processed, irrelevant-object-free dataset to improve detection accuracy.

21. The method of claim 20, wherein the deep learning model comprises a convolutional neural network or an attention-based architecture designed for image classification.

22. The method of claim 20, wherein step of training the deep learning model with the training data set comprise a training computing system comprising one or more processors and a memory, wherein the memory can store data and instructions which are executed by the processor to cause the training computing system to perform operations.
